(19) United States
(12) Patent Application Publication
(10) Pub. No.: US 2001/0042023 A1
(43) Pub. Date: Nov. 15, 2001

(54) Product fulfillment system

(76) Inventors: Scott Anderson, Heathrow, FL (US); Shawn Lucas, Heathrow, FL (US)

Correspondence Address: Sheldon Parker, Suite 300, 300 Preston Avenue, Charlottesville, VA, 22902, US

(21) Appl. No.: 09/767,090

(22) Filed: Jan. 22, 2001

Related U.S. Application Data
(60) Provisional application No. 60/177,327, filed on Jan. 21, 2000.

(51) Int. Cl. G06F 17/60

(52) U.S. Cl. 705/26

(57) ABSTRACT

The present invention relates to an order fulfillment and tracking system. The system includes the steps of loging-on to a central computer, from a remote product buyer computer, via a network, selecting products to be ordered, transmitting data to the central computer, the data identifying the products to be ordered and buyer's shipping address, transmitting the data from the central computer to at least one first selected supplier, identifying on the at least one first selected supplier's computer the buyer's selected ordered product, transmitting data from the central computer to a plurality of second selected suppliers, the data representing any ordered product of step (e) that is not responded to by a first selected supplier within a predetermined small time period, and transmitting data from the central computer to a plurality of third selected suppliers, the data representing any ordered product of step (e) that is not responded to by a second selected supplier within a predetermined small time period.

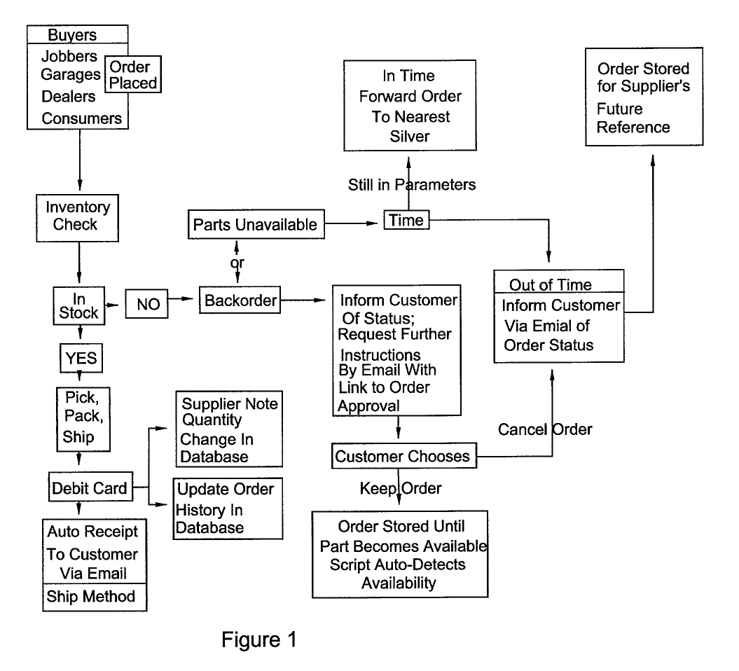

### CROSS-REFERENCE TO RELATED PATENT APPLICATION

This application claims the benefits under 35 U.S.C. 119(e) of provisional patent application Ser. No. 60/177,327, filed Jan. 21, 2000. This application incorporates by reference, as though recited in full, the disclosure of co-pending provisional application 60/177,327.

### BACKGROUND OF THE INVENTION

### FIELD OF THE INVENTION

The present invention relates to a computer network system for product order control and tracking, and more particular, to a system for rapidly fulfilling multiple orders from a plurality of suppliers.

### SUMMARY OF THE INVENTION

The present invention relates to an order fulfillment and tracking system. The system includes the following process steps:

a) log-on to a central computer, from a remote product buyer computer, via a network

b) selecting products to be ordered,

c) transmitting data to said central computer, the data identifying the products to be ordered and buyer's shipping address,

d) transmitting the data from the central computer to at least one first selected supplier,

e) identifying on the at least one first selected supplier's computer said buyer's selected ordered product,

f) transmitting data from said central computer to a plurality of second selected suppliers, said data representing any ordered product of step (e) that is not responded to by a first selected supplier within a predetermined small time period, and

g) transmitting data from the central computer to a plurality of third selected suppliers, the data representing any ordered product of step (e) that is not responded to by a second selected supplier within a predetermined small time period.

The first selected supplier is selected from a list of eligible supplier, with the selection being on the basis of a supplier's distance from the buyer's shipping address, and with the nearest supplier being given priority over other eligible suppliers. If there is a tie between suppliers the tie is broken on a random basis. The predetermined small time period is preferably approximately five minutes.

In the process, if no first selected supplier identifies to the central computer that an ordered product is in stock within a time period of approximately five minutes, then the next group of eligible suppliers are provided with the opportunity to identify to the central computer that an ordered product is in stock.

Advantageously the second selected suppliers is a substantially larger group than the first selected suppliers group, and the third selected suppliers is a substantially larger group than the second selected suppliers group and the process of providing access to successively larger group continues until all possible suppliers have access to the order. Advantageously, essentially all eligible suppliers have access to identify a product as being in stock, if prior suppliers fail to identify a product as being in stock. Preferably when a buyer enters data indicating that buyer accepts same day delivery and thereby gives priority to a supplier providing same day deliver over a supplier who identifies an ordered product as being back ordered or unavailable.

### BRIEF DESCRIPTION OF THE DRAWINGS

The FIGURE is a flow chart of the process of the present invention.

### DESCRIPTION OF THE PREFERRED EMBODIMENTS OF THE INVENTION

The invention can be described by viewing an example of an order control tracking service provider system.

### EXAMPLE

Order Control Tracking

Networking Environment

During business hours, at the supplier's offices at least one computer is on line with the back-end software of the order control tracking service provider's web site, as for example, Parts.com. The software provides automatically updated lists of orders ready to be fulfilled, returns to be processed, offers order tracking and historical information as well as managerial and accounting reports.

Order fulfillment

A prospective buyer logs on to the system from a remote computer station, most commonly, via the internet. When the buyer completes an order, the order's selected item or items change status to “ordered” and selected suppliers begin seeing the selected item or items on their remote supplier computer screens. The eligible suppliers are sorted in order of distance from the buyer's shipping address, on the basis of nearest to furthest. When sorting, the tiebreaker for same distance is a round robin (order number plus supplier number, then modulo maximum supplier number).

In the first 5 minutes after the order is completed, the nearest eligible supplier is the only one who sees the item or items displayed on a computer screen by the back-end software. If the prospective supplier does not mark the item or items as “in stock” within the 5 minutes, the next 100 eligible suppliers have access, and after another 5 min, the nest 1000 eligible suppliers have access. This process continues until all possible suppliers have access to the order. Within 30 minutes, every eligible supplier may handle the fulfillment of the Item if it's not already in stock at a nearer eligible supplier. This method gives the nearest eligible supplier some exclusive time period in which to make a reasoned inventory decision, and yet within a reasonable amount of time, the system also can find a supplier for scarce, infrequently stocked products.

Preferably, orders for multiple products are assigned to a single supplier or a minimum number of suppliers. In order to avoid breaking an order of several items between several competing suppliers, all items for the order (of a make or brand, for which the supplier is an eligible source) are marked on the form at the same time. Optionally, orders containing a large number of items can be broken down so that availability may be reasonable checked in 5 minute time period.

In addition to indicating each item on the computer screen form, the possible computer screen buttons are:

In stock

Backordered until [Supplier must fill in date] only selectable by predetermined authorized supplier levels, and only if same day delivery in not required)

Unavailable (default when the form opens)

If the eligible supplier is local and the buyer prefers delivery rather than shipping, the form can display fields for the delivery's estimated time of arrival.

If the nearest eligible supplier does not respond within 5 minutes, the next 10 nearest eligible suppliers see the items. The order is considered filled if the nearest eligible supplier responds that all items are “in stock”. Otherwise items not in stock move to the next 10 nearest eligible suppliers. Those suppliers only see the partial order that is yet unfilled. The software does not necessarily wait for 5 min to elapse; for example, as soon as all suppliers in this 5 min period have responded to all items of the specific order, the order is ready to escalate to the next group of suppliers, if appropriate.

Since competing suppliers can be submitting the form to the central computer, a “first come first serve” procedure can be employed according to the following status precedence:

When a supplier responds “backordered, it bumps “unavailable”

When a supplier responds “in stock”, it bumps “unavailable”

When the Buyer accepts same-day delivery, and a local Supplier responds “in stock”, it bumps “backordered” or “unavailable”

The term “bumps” as employed herein, refers to the procedure of displacing or preempting a competing supplier.

Naturally, any item whose status can't be bumped by any subsequent supplier should not be displayed to those suppliers.

Once all Items on the order have a status of “in stock” or there is no further potential for other suppliers to bump a status (always within 30 min), an email is automatically sent to the buyer showing the status of each item. Potentially, a complex case may show some items as being “in stock” at local suppliers (delivering today), other items as being “in stock” at non-local suppliers (shipping today), other items as “backordered” (shipping later at an estimated date), and yet other items as unavailable at any eligible supplier.

Order Delivery

The computer software generates and displays a summary of orders and items ready to deliver (with at least one Item status of in stock) and perhaps ready to deliver (with at least on time status of backordered) by the specific supplier. Smaller suppliers that handle relatively lower volume, may view orders and their items listed 10 orders at a time, whereas larger suppliers will search for and release backorders by product part number that they have received, and process orders in a queue one by one (with potentially several pick/pack/ship supplier agents logged in and reading from the queue).

However the supplier agent arrives at an item with “backordered” status, the supplier agent can change the status to “in stock” to move the item to the ready-to-deliver list. If it is determined that the item will probably not arrive in a reasonable time, the supplier agent can click a link to email the order tracking service web site's staff member who can mark this “unavailable”. The tracking service provider's web site will charge the supplier an abandonment fee of $25 per Item. Likewise, however the supplier agent arrives at an item with in stock status, he may click a link to email a Parts.com staff member who can mark this “backordered” or “unavailable”, and charge the same fee.

By viewing the page showing a single order ready to deliver, all Items that were “in stock” are changed to “delivering” (disallowing the buyer to cancel). The supplier agent has 60 min to pick and pack the items and submit a form with the purchase order number, shipment tracking number and shipping charge (for non-local suppliers) or the purchase order number and delivery fleet vehicle number (for local suppliers). This marks all items that were “delivering” as now “delivered”. If 60 min elapses and the form is not completed, the tracking service provider will charge the supplier an abandonment fee of $25 per item. That is why the queue showing the next ready order, the choices are set to “deliver and continue” and deliver and quit”.

When the form is submitted, the credit card payment that was previously authorized is now captured for the items actually delivered along with the shipping cost, if any. Any remaining Items that are “backordered” should remain authorized for future capture, and those that are “unavailable” have their authorization voided.

The credit card capture is made using a transaction date of when the original items were marked “ordered”, and a posting date of today. Of the amount captured on credit card:

The tax is divided up between Tax Authorities and added to their current amounts payable as of the transaction date.

Commissions are computed on the non-tax, non-shipping item subtotals (may each have different suppliers) according to the rates below, all commissions are added to their respective current amounts payable as of the posting date.

| Commission Recipient | Consumer Buyer | Business Buyer |
|---|---|---|
| tracking service provider | 5.0% | 3.0% |
| High level Supplier | 2.5% | 1.0% |
| Lower level Supplier | 1.0% | 0.5% |

The remaining Items subtotals and shipping cost is added to the current amounts payable to the delivering supplier as of the posting date.

An email is sent to the buyer with the subject “Order # . . . delivered”. It starts with “PARTS.COM needs your feed back in maintaining our high quality standards” and lists the order, its items and delivery expectations. It includes a link to the buyers “order tracking and returns” page and urges the buyer to visit this link after receiving and inspecting the products.

Order Returns

This display shows a summary and details of “Order Items” that the buyer has marked “returning”. The supplier agent then arranges for a delivery fleet vehicle to pick up the item or, if originally shipped, provide supplier-paid pick up service. Arrangements can be commented at this display, including return shipment tracking number or delivery fleet vehicle number. Once the returned item is received, the supplier agent can click a link to mark the Item status “returned”.

All of the computed amounts added to payables during the delivery process (above) are reversed, though the accounting period used are the earliest one(s) unpaid from which to debit. If the refund exceeds the amounts payable for any supplier, an automatic email is sent to order control tracking service provider's accounting department to collect from that supplier. Either way, the credit card refund is automatically processed immediately.

Order Tracking and History

A supplier agent can pull up a current or historical order ad hoc to view the items and details, including current status on each order. This is just like the buyer's “order tracking and returns” page, except all actions are disabled.

Reports

The manager's overview report has several at-a-glance sections on a single page, that is on a single computer screen:

Sales Activity (rows: closing % that is, actual sales divided by potential sales if everything were “in stock” and marked as soon as it appeared in the system), gross sales, net sales, commissions received from others, abandonment fees, net income; columns: year to date, month to date, and last five daily posting including the current day)

Missed Sales (top five products not in stock that resulted in a missed sale during the prior month)

Backorders (top five oldest items backorder)

Refund Reasons (top five number of incidents per supplier agent and reason)

Abandonment (top five numbers of incidents per supplier agent)

The backorder report lists all orders and at least one item on backorder status.

The products report lists all OEM part numbers ordered over the given date range, showing quantities ordered, quantities marked in stock quantities marked backordered, quantities marker unavailable, and quantities returned.

The orders report lists all orders and their Items (eligible for this Supplier), whether current or historical, for the given date range.

Additionally, the Workflow Console can show real-time workload for the suppliers' agents currently logged in, as well as queue lag times. This can be a decision making tool for managers to size and schedule their staff as well as review performance from specific staff members.

The tracking system can interface with complimentary systems such as Reynolds & Reynolds, ADP and UCS. Inventory reports can be generated periodically and differences from the previous report can be sent to the order control tracking service provider to update its database of current inventory.

Additionally, when an order comes in, the system can be configured to mark in stock items automatically and ready them for pick/pack/ship. Further interfacing with manufacturing suppliers, such as OKABE, and their factory resource systems such as SAP can be provided. The order control tracking service provider can also interface with systems using industry standards like EDI, IDOC, and XML.

Interface with Supplier System

A page is provided to identify the list price of a product unknown to the internal database. Therefore, parts advisors only need to work on one item at a time. It shows the item, with make, model, year and comments and the parts advisor looks up the correct OEM part number and list price out of other reference data, whether as a book or in digital format. With several parts advisors working during any single shift, a single queue of unknown items feeds the next available parts advisor. The queue of items can be split by make to increase the familiarity by the parts advisor.

When a Buyer needs advice, the first chat message is generated automatically, such as “Hi, I'm Fred, what Mustang GT parts are you looking for?” The name Fred is an alias that could apply to any parts advisor who then will be dedicated to this buyer during the length of this order. Multitasking enable a parts advisor to support several chats simultaneously.

A chat will result in one of these situations:

The Order Item is resolved to a product with a known price.

The Buyer hangs up and continues shopping on his own.

The Parts advisor may hang up and block further chats from this Buyer.

Parts Advisor Queue Manger

The system can integrate with an industry standard call center operation software system for queuing and routing calls and chats within the 24 hour 7 day order control tracking service provider's operations center, especially when it involves advanced telephony.

Parts Advisor Quality Manager

Reports are generated showing summaries and details for parts advisors, indicating the number of chats they've engaged in, quantitative ratings from buyers, their items returned to items ordered ratio, etc. Another report shows the leading number of incidents of parts advice and returns, grouped by make, model and category. Within the group, it shows specific products next to which the buyer clicked to contact a parts advisor. This report assists in the continual cleaning and enhancing of the OEM catalog. Permitted parts advisors can be permitted to edit OEM catalog online when mistakes are found and confirmed. These edits can be authenticated or confirmed by acceptance from another parts advisor before being committed and visible to all other users.

Accounting Reports

The reported identified as a credit Card Settlement Report shows all posted charge captures and refunds, sorted by credit card type and then by posting date. This is used to reconcile merchant account activity.

The Supplier Payable Report shows all non-zero daily periods for each supplier within the given date range. The same columns are included as are on the sales activity section of the Manager's Overview Report in order the control tracking service provider system.

The Tax payable Report shows all non-zero quarterly periods for each Tax Authority.

There is no posting step to indicate that the order control tracking service provider has paid a period. It is assumed by the system that periods over 3 days old have been paid and that today, yesterday, the day before, and three days ago are still unpaid.

The foregoing example illustrates one specific embodiment of the invention. It should be understood however, that various details of the example are representative examples and are not intended to indicate a narrow construction of the invention. For example, the eligible suppliers can be sorted by a priority other than order of distance from the buyer's shipping address, as for example, suppliers priority can be weighted on the basis of customer ratings, history of quality of service, ability to provide product rapidly or other criteria.

Reference to time periods such the time period of 5 minutes after the order is completed can be scaled upwardly or downwardly depending upon experience with the system. Similarly the incrementing of suppliers from the nearest, to the next 100, and after another 5 min, to the nest 1000 eligible suppliers, can be modified as needed. In the first instance for example, the buyer can be offered the opportunity to place an order with a plurality of first tier suppliers. This process need only continue until all possible suppliers have had access to the order. Within a limited time period, as for example 30 minutes, every eligible supplier can be given the opportunity to handle the fulfillment of the item if it's not already in stock at a nearer eligible supplier.

This critical factor is to give priority to the nearest eligible supplier by virtue of an exclusive time period while, within a reasonable amount of time, finding a supplier for scarce, infrequently stocked products.

While it is preferably to assign orders for multiple products to a single supplier or a minimum number of suppliers the system can provide for a reasonable sharing of an order, as for example, in order to expedite processing of the order.

It is again noted that time periods identified in the example are preferred approximate time periods that can be scaled upwardly or downwardly to suit specific contingencies.

The reference in the example to the listing of 10 orders at a time, is noted to be a preferred quantity but larger listings can also be provided.

The tracking service provider's web site charging of an abandonment fee of $25 per item is a preferred, representative value. The fee can range from zero to any desired value.

The supplier agent has been noted as having approximately 60 min to pick and pack the items and submit a form with the purchase order number, and other relevant information. Again, this time period is preferred but is not narrowly critical. All time periods are noted to be approximate.

What is claimed is:

1. A method of order fulfillment and tracking comprising the steps of:
a) log-on to a central computer, from a remote product buyer computer, via a network
h) selecting products to be ordered,
i) transmitting data to said central computer, said data identifying said products to be ordered and buyer's shipping address,
j) transmitting said data from said central computer to at least one first selected supplier,
k) identifying on said at least one first selected supplier's computer said buyer's selected ordered product,
l) transmitting data from said central computer to a plurality of second selected suppliers, said data representing any ordered product of step (e) that is not responded to by a first selected supplier within a predetermined small time period,
m) transmitting data from said central computer to a plurality of third selected suppliers, said data representing any ordered product of step (e) that is not responded to by a second selected supplier within a predetermined small time period.

2. The method of claim 1, wherein said first selected supplier is selected from a list of eligible supplier, said selection being on the basis of a supplier's distance from said buyer's shipping address, with the nearest supplier being given priority over other eligible suppliers.

3. The method of claim 2, wherein a tie between suppliers is decided on a random basis.

4. The method of claim 1, wherein said predetermined small time period is approximately five minutes.

5. The method of claim 1, wherein if no first selected supplier identifies to said central computer that an ordered product is in stock within a time period of approximately five minutes, then the next group of eligible suppliers are provided with the opportunity to identify to said central computer that an ordered product is in stock.

6. The method of claim 5, wherein said second selected suppliers is a substantially larger group than said first selected suppliers, and said third selected suppliers is a substantially larger group than said second selected suppliers.

7. The method of claim 6, wherein essentially all eligible suppliers have access to identify a product as being in stock, if prior suppliers fail to identify a product as being in stock.

8. The method of claim 6, wherein the process of providing access to successively larger group continues until all possible suppliers have access to the order.

9. The method of claim 6, wherein the process of providing access to successively larger group continues until all possible suppliers have access to the order within approximately a thirty minute time period.

10. The method of claim 1, further comprising the step of a supplier identifying an ordered product as being backordered.

11. The method of claim 10, wherein a supplier that identified an ordered product as being in stock takes priority over a supplier that identifies an ordered product as being unavailable or on back order.

12. The method of claim 1, wherein a buyer enters data indicating that buyer accepts same day delivery and thereby gives priority to a supplier providing same day deliver over a supplier who identifies an ordered product as being back ordered or unavailable.

13. The method of claim 1, further comprising the step of authorizing a supplier agent to change the status of an ordered product from in stock a ready-to-deliver status.
